(19) United States
(12) Patent Application Publication
(10) Pub. No.: US 2009/0300107 A1
(43) Pub. Date: Dec. 3, 2009

(54) Presence Service Provision System and Server Unit Thereof

(75) Inventor: Ryo Araki, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/469,579

(22) Filed: May 20, 2009

(30) Foreign Application Priority Data
May 30, 2008 (JP) 2008-143236

(51) Int. Cl. G06F 15/16; G06F 17/30

(52) U.S. Cl. 709/203; 707/10; 707/E17.032

(57) ABSTRACT

According to one embodiment, a presence service provision system comprises terminal devices configured to be any of a discloser and a requester of presence information and a server for distributing to the requester distribution information including the presence information to be individually notified from the discloser upon occurrence of an event. The terminal devices include a notification module notifies operation information showing a user's operation posed the event to the server upon notifying the presence information. The server includes an extended information database, a generation module and a distribution module. The extended information database stores extended presence information in which the notified presence information is associated with the operation information. The generation module generates extended distribution information in which the distribution information is associated with the operation information acquired from the extended information database. The distribution module distributes the extended distribution information to the requester.

### CROSS-REFERENCE TO RELATED APPLICATIONS

This application is based upon and claims the benefit of priority from Japanese Patent Application No. 2008-143236, filed May 30, 2008, the entire contents of which are incorporated herein by reference.

### BACKGROUND

1. Field

One embodiment of the invention relates to an improvement of a system for providing a presence service.

2. Description of the Related Art

In recent years, the Internet Protocol (IP) technology has remarkably developed. Technical development in a telephone system using an IP network, or so-called Voice over IP (VoIP), has become active. The presence service is one of services using the IP technology. The presence service enables members to share user's states (online, offline, busy, at desk, away from desk, during communication, etc.) in a network. Users (or client terminals) on sides from which the service presence is disclosed are referred to as presentities, and users (or client terminals) on sides from which the service presence is browsed are referred to as watchers.

Meanwhile, improving the performance of central processing units (CPUs) of computers, and improving software make it possible for recent telephone systems to have extremely many functions. However, although sufficient operation manuals have been prepared, end users (many of them are business persons) know not much about the many and convenient functions. The fact that the end users rarely refer to the manuals poses a cause, and to begin with, the end users have no time to read the manuals.

Therefore, there is some possibility of providing useful information such as operation manuals and guidance from terminals to the users by using the presence services that are information sharing services among users. A system having such a function has not been known yet. A technique which extends presence information and enables defining the user's (or client's) statuses in detail is disclosed in Jpn. Pat. Appln. KOKAI Publication No. 2007-280416. However, the information treated in this reference is still remains within the limit of a framework of “status”, it is impossible to share the information such as operation guidance among users.

As mentioned above, using the presence services makes it possible to construct further convenient system by displaying guidance messages.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view depicting an embodiment of a presence distribution system of the invention;

FIG. 2 is an exemplary functional block diagram depicting a substantial configuration of a private branch exchange system 100, a presence server 200 and a VoIP client of FIG. 1;

FIG. 3 is an exemplary view depicting an example of a data structure of extended presence information to be stored in an extended information database 200b;

FIG. 4 is an exemplary view depicting a distribution reservation sequence of the extended presence information of the embodiment of the invention;

FIG. 5 is an exemplary view depicting a first embodiment of a sequence regarding a distribution of the extended presence information;

FIG. 6 is an exemplary view depicting an example of extended presence information of a first embodiment;

FIG. 7 is an exemplary view depicting a second embodiment of the sequence regarding the distribution of the extended presence information;

FIG. 8 is an exemplary view depicting an example of extended presence information of a second embodiment; and

FIG. 9 is another exemplary view depicting an example of the extended presence information of the second embodiment.

### DETAILED DESCRIPTION

Various embodiments according to the invention will be described hereinafter with reference to the accompanying drawings. In general, according to one embodiment of the invention, there is provided a presence service provision system comprises terminal devices configured to be any of a discloser and a requester of presence information and a server unit for distributing to the requester distribution information including the presence information to be individually notified from the discloser upon occurrence of an event. Each of the terminal devices includes a notification module which notifies operation information showing a user's operation posed the event to the server unit upon notifying the presence information. The server unit includes an extended information database, a generation module and a distribution module. The extended information database stores extended presence information in which the notified presence information is associated with the operation information. The generation module generates extended distribution information in which the distribution information is associated with the operation information acquired from the extended information database. The distribution module distributes the extended distribution information to the requester.

By taking such a measure, when a presentity notifies its own presence to a server, in addition to this, the presentity notifies information showing an operation by a user in the presence. The server associates the notified presence with the operation information and stores it in a database. When the server distributes information to watchers by using a framework of the existing presence service, the server reads operation information corresponding to statuses of the watchers from the database. The server also distributes this operation information to the watchers together with the presence information. Therefore, the user becomes able to appropriately perform operations corresponding to each time. Thus, the convenience of the presence server may be improved.

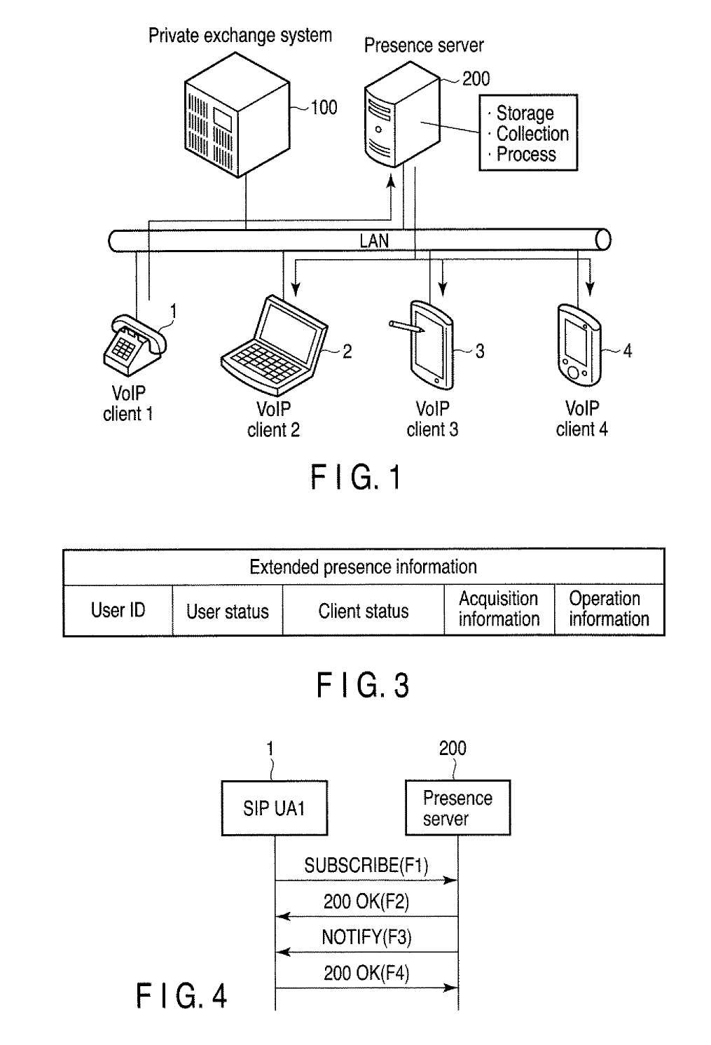

According to an embodiment, FIG. 1 shows an exemplary view illustrating an embodiment of an IP telephone system of the invention. In FIG. 1, a plurality of VoIP clients 1-4 are accommodated in a private branch exchange system 100 via a local area network (LAN). A status of each VoIP client (and its user) is monitored by a presence server 200 to be connected to the LAN. The presence server 200 may be implemented in the exchange system 100 as a function thereof.

Each VoIP client 1-4 may be any one of a discloser (presentity) and a requester (watcher) of presence information in relationships to other clients. The watcher declares a client intending to be the presentity and the fact that the watcher itself becomes a watcher to the presence server 200 through a “SUBSCRIBE” message.

In the embodiment, it is assumed that the IP telephone system uses a presence service by means of SIP which is compliant with Request for Comment (RFC) 3265, and RFC 3903 of the Internet Engineering Task Force (IETF). Further, in the embodiment, management, including information on operations by the user, in addition to the information of the status of the VoIP client terminal and of the status of the user of the terminal, is achieved. The status of the client terminal includes idle, in transmission, in communication, on hold, in incoming call, in transfer setting, etc. Hereinafter, the information integrating the above statuses is referred to as extended presence information.

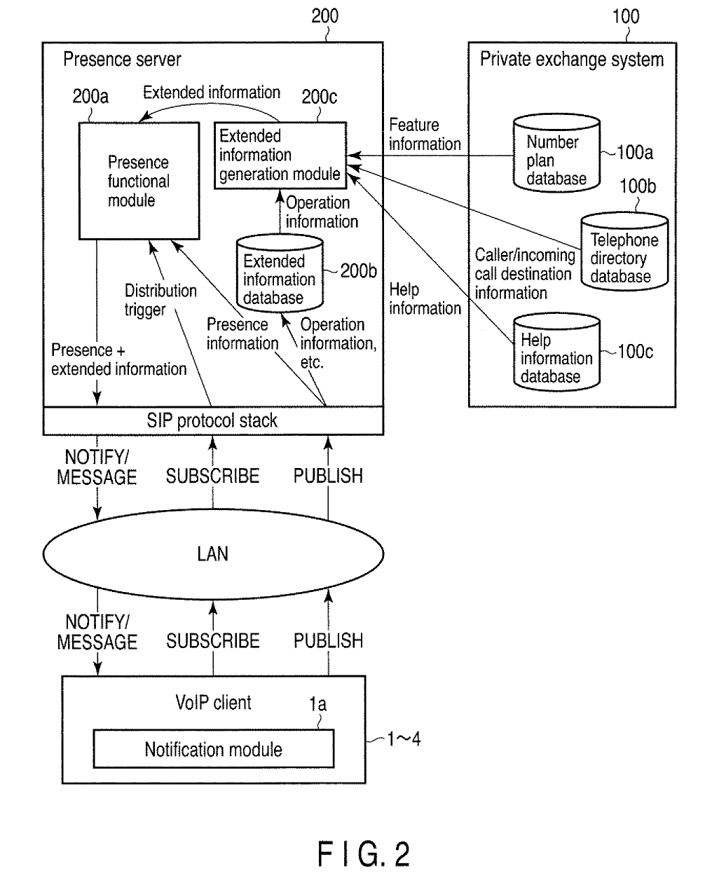

According to an embodiment, FIG. 2 shows an exemplary functional block diagram illustrating a substantial configuration of the private branch exchange system 100, the presence server 200, and the VoIP client. In addition to a presence functional module 200a, the presence server 200 includes an extended information database 200b, and an extended information generation module 200c. The functional module 200a achieves the presence service through SIP under a SIP protocol stack.

The extended information database 200b receives and stores extended presence information included in a SIP message to be transmitted and received via the LAN. The extended information generation module 200c reads the information stored in the extended information database 200b and generates distribution information in order to distribute to a user. In the embodiment, the generation module 200c generates the distribution information by combining the operation information with usual presence information. This new distribution information is called extended distribution information.

The presence server 200 stores the extended presence information to be notified from the VoIP clients at each occurrence of events in the extended information database 200b. When a distribution trigger is given from the presence SIP protocol stack, the functional module 200a distributes the extended distribution information generated from the generation module 200c to the watchers.

The extended information generation module 200c acquires operation information corresponding to statuses of the statuses of the clients (watchers) requesting the distribution of the presence information from the extended information database 200b. Then, the generation module 200c generates the extended distribution information by combining the operation information with the original presence information. To generate the extended distribution information, a number plan database 100a, a telephone directory database 100b, and a help information database 100c, etc., provided for the private branch exchange system 100 are utilized.

For instance, referring to the telephone directory database 100b by using a dial number column, which has been given as the operation information, as a key enables specifying the information of a caller's name and an incoming call destination. Referring to the plan database 100a enables specifying a started feature. Further, the information database 100c may be used so as to call help information of the specified feature.

The extended information generated from the extended information generation module 200c is provided to the presence functional module 200a. The functional module 200a transmits the extended information to the LAN by including the extended information in the SIP message such as messages of “NOTIFY” and “MESSAGE”. The functional module 200a performs, as a main unit, the generation and transmission/reception of the message.

The VoIP client is provided with a notification module 1a. When a status change event such as off-hook and channel acquisition key-press occurs, the notification module 1a notifies the fact of the occurrence to the presence server 200 through a “PUBLISH” message. Especially, the notification module la adds a postscript of the operation information showing the user's operation which has caused the status change event to the “PUBLISH” message. Thereby, the extended presence information including the operation information is notified to the presence server 200.

According to an embodiment, FIG. 3 is an exemplary view illustrating an example of a data structure of the extended presence information to be stored in the extended information database 200b. The presence information in the presence service is generated by combining a user Identification (ID) with user's status. The status includes a status of a user itself, and/or a status of a client. In the embodiment, the extended presence information includes information in which the presence information is integrated with acquisition information and the operation information. The user ID may be any data as long as the user ID can uniquely specify the user; however, to utilize a presence service model by SIP, it is preferable for the user ID to use a SIP uniform resource identifier (SIP URI).

As regards user's status, the status to be defined by the conventional presence service, such as “online”, “offline”, “busy”, “away from desk”, etc., are possible approaches. As regards client status, such as “idle”, “during origination”, “during communication”, “on hold”, “during termination”, “during transfer setting”, etc., can be assumed.

The information for acquiring the client's status is set in the acquisition information. For instance, if the client status is the “during termination” or the “during communication”, the telephone number of the partner becomes able to be acquisition status. The operation which has been done so as to shift the client status to the acquisition status is set to the operation information. For instance, in a case in which a channel key of a client terminal is pressed in order to respond to an incoming call, and in which the client status is shifted to “during communication”, a code indicating the pressed channel key is set to the operation information.

Any of the acquisition information and the operation information may be expressed in various forms. For instance, in the presence service through SIP, an Extensible Markup Language (XML) form is used in order to express the presence information. In this embodiment, in accordance with the above expression, by extending an XML of the existing presence information in a way such as defining a new tag, the acquisition information and the operation information can be expressed.

FIG. 4 is an exemplary view illustrating a distribution reservation sequence of the extended presence information in the embodiment. In FIG. 4, a SIP user agent (SIP UA) requesting the presence service describes the fact of setting itself as a watcher and of setting the SIP UA expecting to acquire the extended presence information as a presentity in the SUBSCRIBE (F1) message. The setting information of a distribution period is described in the SUBSCRIBE (F1) message and the message is transmitted to the presence server 200.

If a distribution reservation request described in the SUBSCRIBE (F1) message is appropriate, the presence server 200 returns a 200 OK (F2) message. Immediately, the presence server 200 distributes first time extended presence information by means of a NOTIFY (F3) message. When receiving the NOTIFY (F3) message, a SIP UA1 1 responds by returning a 200 OK (F4) message. After this, at every time when the extended presence information is updated, the presence server 200 performs information distribution to SIP UA1 1 through the “NOTIFY” message. The sequence is compliant with RFC 3265; however it is also able to make a change and an extension for flexibly coping with the extended information. The following will describe operations of the IP telephone system with the above configuration by dividing the system into two embodiments.

### First Embodiment

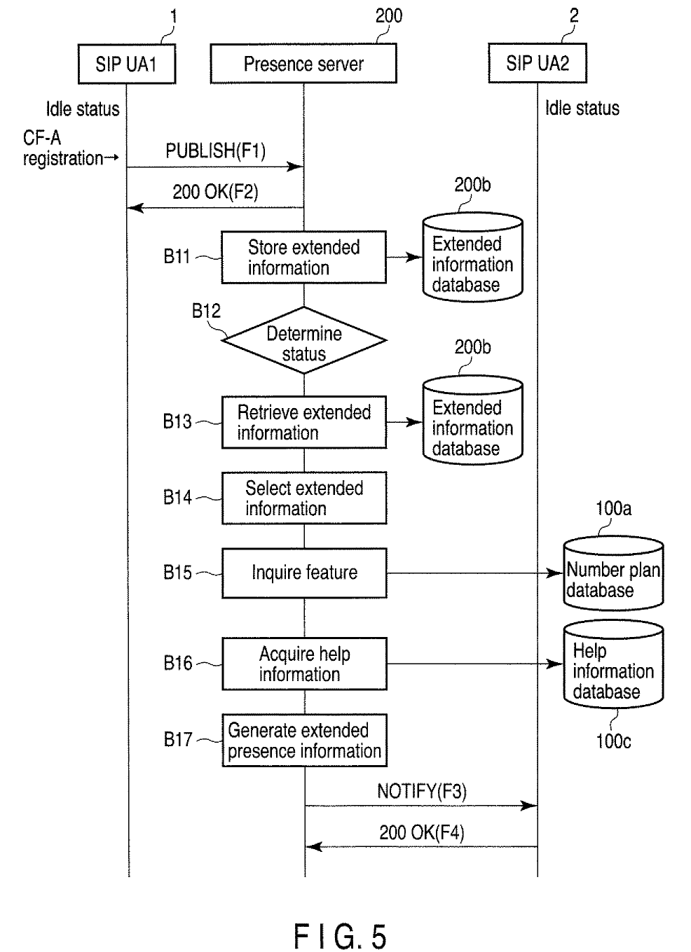

FIG. 5 shows an exemplary view illustration a first embodiment of a sequence regarding the distribution of the extended presence information. A Call Forward All (CF-A) is assumed as an example of a feature, and a special number for calling the CF-A is set to “#6011”. The first embodiment will be described on the assumption that SIP UA1 1 is registered as the VoIP terminal 1, SIP UA2 2 is registered as the VoIP terminal 2, and SIP UA2 2 is registered as a watcher for SIP UA1 1 in FIG. 1, respectively.

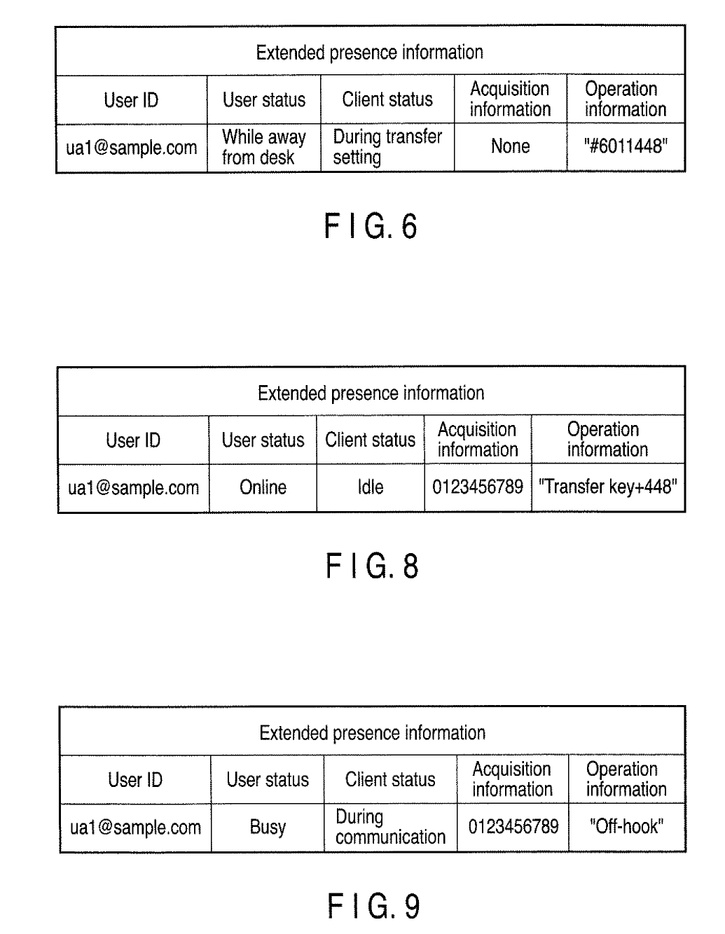

In FIG. 5, when a user of a terminal 1 in an idle status presses the special number “#6011”, the extended presence information shown in FIG. 6 is set to the PUBLISH (F1) message, and the information is returned to the presence server 200. After returning the 200 OK (F2) message to the terminal 1, the presence server 200 stores the extended presence information shown in FIG. 6 in the extended information database 200b (Block B11).

The presence server 200 then generates the NOTIFY (F3) message for notifying the status of the terminal 1 to the terminal 2 in FIG. 1. The presence server 200 also determines the status of the terminal 2 by referring, for example, to the extended information database 200b (Block B12). The status of the terminal 2 is in an idle status. Therefore, the presence server 200 retrieves the information database 200b (block B13) and selects at least one item of operation information in an idle status (Block B14). Here, it is assumed that information shown in FIG. 6 has been selected. The selected extended information (operation information) is set as it is to the NOTIFY (F3) message.

The presence server 200 then inquires the number plan database 100a about the feature corresponding to the acquired operation information (Block B15). Thereby, it becomes clear that a dial column “#6011” is a start code of the CF-A, and a dial column “448” positioned in the rear thereof is an extension number. Then, the presence server 200 acquires help information (e.g., a link to help information, or text data, etc.) by referring to the help information database 100c (Block B16), and sets the help information in the NOTIFY (F3) message. Thereby, the extended presence information is generated (Block B17).

A guidance message may be set in the extended presence information as information for operation support of the CA-F. A content item of the guidance message is, for example, “when #6011+extension number are dialed, CF-A may be set in specified extension number”. The terminal 2 receives the NOTIFY (F3) message. The terminal 2 then reads the guidance message from the extended presence information which has been set to the NOTIFY (F3) message to display the guidance message as it is on a display.

As described above, in this embodiment, the presentity notifies not only its own status but also the operation information produced by the user to the presence server 200. That is, the message to be notified from the presentity to the presence server 200 includes the operation information in addition to its own status. The presence server 200 stores the extended presence information in which the presence information and the operation information are combined with each other in the extension information database 200. The presence server 200 reads the operation information corresponding to the status of the watcher from the extended information database 200 when performing the information distribution to the watcher. The presence server 200 then notifies the operation information to the watcher together with the presence information.

That is, in the first embodiment, the IP telephone system includes a database storing the operation information therein. When distributing the presence information of the client to other clients by using the presence service model, the IP telephone system selects the operation information corresponding to the status of the client from the database.

In this way, storing the information on the operations performed by the users in a database form enables distribution of the operation information corresponding to the statuses of the clients (watchers) for distributing the presence information. Therefore, the presence service provision system (IP telephone system) makes it possible for the users of the client terminals to select and execute appropriate actions corresponding to the statuses of the clients without referring to manuals. Further, since the presence distribution system enables distribution of the help information, each user may know various features used by other users, and also may obtain the guidance related to the operations. According to these facts, the convenience of the presence service provision system may be enhanced.

### Second Embodiment

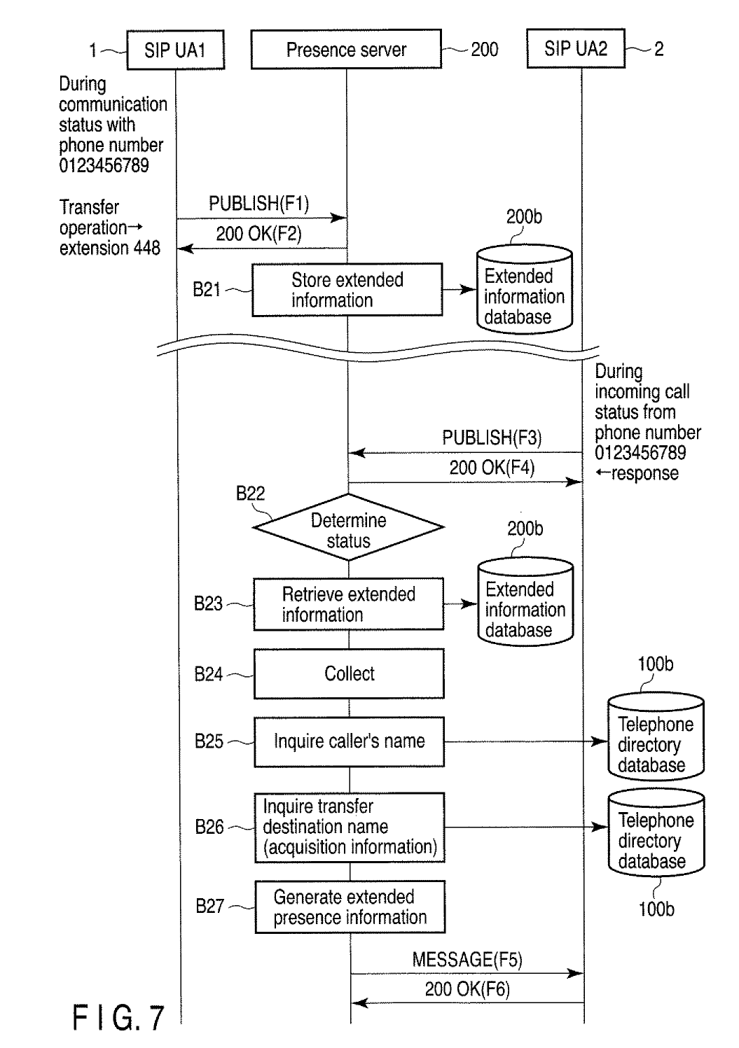

FIG. 7 is an exemplary view illustrating a second embodiment of a sequence regarding a distribution of the extended presence information. In the second embodiment, a “MESSAGE” method defined in RFC 3428 is mounted on the presence server 200 and the extended presence information is distributed in the “MESSAGE” method. In the sequence of FIG. 7, a status is assumed in which the user of the terminal 1 presses a transfer key of the terminal 1 during communication with the partner of the phone number 0123456789, and dials “448” to perform a transfer operation to an extension 448. When the terminal 2 receives an incoming call from the same phone number 0123456789 and when the user makes a response, the extended presence information is distributed to the terminal 2.

In FIG. 7, when the user of the terminal 1 performs the transfer operation, the extended presence information as is shown in FIG. 8 is notified through the PUBLISH (F1) message to the presence server 200. A partner's phone number “0123456789” is set as acquisition information in the extended presence information of FIG. 8. Pressing of a transfer key and a transfer destination extension number 448 are set in the operation information.

The presence server 200 which has received the “PUBLISH” message returns the 200 OK (F2) message to the terminal 1, and stores the extended presence information in the extended information database 200b (Block B21). After this, when an incoming call from the phone number “0123456789” arrives again, and when the terminal 2 responds thereto by off-hook, the terminal 2 shifts from an idle status to a communication status. Then, the terminal 2 sets extended presence information shown in FIG. 9 in the PUBLISH (F3) message to transmit it to the presence server 200.

The presence server 200 stores the extended presence information of FIG. 9 in the extended information database 200b to determine the status of the terminal 1 (Block B22). The presence server 200 then retrieves the information database 200b (Block B23), collects operations performed during communication with the phone number “0123456789” to obtain statistical data (Block B24). From the result obtained through this processing, the presence server 200 selects at least one operation to be frequently performed. Here, it is assumed that the transfer to the extension 448 has the highest operation frequency.

The operation information showing the transfer operations includes such information as “transfer from terminal 1 to extension 448”.

The extended presence information may be generated from these pieces of information. Further, to make the extended presence information satisfactory, the presence server 200 inquires about a caller name corresponding to the phone number “0123456789” to the telephone directory database 100b (Block B25), and inquires about the name of the transfer destination to the database 100b by using the acquisition information “0123456789” as a key (block B26).

According to the above mentioned processing, extended presence information (extended distribution information) to be distributed to the terminal 2 is generated, for example, as the following text data (block B27).

“In incoming call from XYZ Company of phone number “0123456789”,

85% of them have been transferred to Alice at extension 448;

10% of them have been transferred to Bob at extension 412; and

5% of them have been transferred to carol at extension 449”.

In other words, by statistical processing for the extended presence information to be stored in the extended information database 200b, statistical information showing the frequency (Ratio) of transfer may be acquired for each partner's extension number. Further, the presence distribution system may specify the partner's name “XYZ” Company which has received the incoming call, and transfer destination's names “Alice”, “Bob” and “Carol” with reference to the database 100b. All items of the information are acquired from each database by using the acquisition information and the operation information, which are described in the extended presence information by associating with the statuses of the users and the clients, as a key. At last, the extended distribution information is set to the MESSAGE (F5), and distributed to the terminal 2.

In this way, according to the second embodiment, to distribute the presence information of the client to other clients, the presence distribution system calculates statistical information from operation content items related to the same feature stored in the database to generate the extended distribution information. That is, the distribution system generates meticulous information by taking steps of obtaining, for example, statistical data of the transfer destinations from the operation information stored in the extended information database 200b, and of collecting the transfer destinations for each frequency. Notifying the meticulous information to users, the users may know appropriate transfer destinations corresponding to their environments.

As mentioned above, according to the first and second embodiments, the convenience of the presence services may be improved. Since the procedures of the first and second embodiments do not depart from the frameworks of the presence services of SIPs, the procedures may be easily mounted on the existing systems. Further, according to the second embodiment, an implicit knowledge (“Telephone call from Mr., or Ms. So-and-so to Mr., or Ms. So-and-so”, etc.) in an environment, in which the distribution system is used, may be presented to the users.

The invention is not limited to the embodiments mentioned above. For instance, by distributing the Quality of Service (QoS) information as the extended presence information, the presence service distribution system may think about uses of alerting the users so as to refrain from making telephone calls in network congestion and of placing transmission and reception restrictions by the VoIP clients themselves.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A presence service provision system comprising:
terminal devices configured to be any of a discloser and a requester of presence information; and
a server unit for distributing to the requester distribution information including the presence information to be individually notified from the discloser upon occurrence of an event, wherein
each of the terminal devices includes:
a notification module which notifies operation information showing a user's operation posed the event to the server unit upon notifying the presence information;
the server unit includes:
an extended information database which stores extended presence information in which the notified presence information is associated with the operation information;
a generation module generates extended distribution information in which the distribution information is associated with the operation information acquired from the extended information database; and
a distribution module which distributes the extended distribution information to the requester.

2. The system of claim 1, wherein
the generation module acquires operation information corresponding to a status of the requester from the extended information database.

3. The system of claim 2, further comprising:
a number plan database in which a plurality of features are associated with operation number for calling the features, wherein
the generation module reads operation numbers of the features corresponding to the acquired operation information from the number plan database and generates the extended distribution information by combining the operation numbers with the distribution information.

4. The system of claim 3, further comprising:
a help information database in which the plurality of features are each associated with help information for operation support, wherein
the generation module reads help information of features corresponding to the acquired operation information from the help information database and generates the extended distribution information by combining the help information with the distribution information.

5. The system of claim 2, wherein
the generation module applies statistical processing to extended presence information to be stored in the extended information database, and involves information showing a frequency of operations to be performed in a status of the requester in the extended distribution information.

6. A server unit provided for a presence service provision system and distributing to a requester distribution information including presence information to be individually notified from a discloser of the presence information upon occurrence of an event, the server unit comprising:
an extended information database in which the presence information notified from the discloser is associated with operation information showing operations of a user posed a notification event of the presence information;
a generation module which generates extended distribution information in which the distribution information is combined with operation information acquired from the extended information database; and
a distribution module which distributes the extended distribution information to the requester.

7. The server unit of claim 6, wherein
the generation module acquires operation information corresponding to a status of the requester from the extended information database.

8. The server unit of claim 7, wherein
the generation module reads operation numbers of features corresponding to the acquired operation information from a number plan database in which a plurality of features are associated with the operation numbers for calling the features, and generates the extended distribution information by combining the operation numbers with the distribution information.

9. The server unit of claim 8, wherein
the generation module reads help information of features corresponding to the acquired operation information from help information database in which the plurality of features are each associated with help information for operation support, and generates the extended distribution information by combining the help information with the distribution information.

10. The server unit of claim 7, wherein
the generation module applies statistical processing to extended presence information to be stored in the extended information database, and involves information showing a frequency of operations to be performed in a status of the requester in the extended distribution information.
